(19) United States
(12) Patent Application Publication
(10) Pub. No.: US 2010/0074992 A1
(43) Pub. Date: Mar. 25, 2010

(54) Delicious Fermented Milk with Low Fat Content and Process for Producing the Same

(76) Inventors: Hiroshi Horiuchi, Kanagawa (JP); Nobuko Inoue, Kanagawa (JP)

Correspondence Address: LICATA & TYRRELL P.C., 66 E. MAIN STREET, MARLTON, NJ, 08053, US

(21) Appl. No.: 12/525,405

(22) PCT Filed: Feb. 6, 2007
(86) PCT No.: PCT/JP2007/052042

§ 371 Date: Jul. 31, 2009

(51) Int. Cl. A23C 9/13

(52) U.S. Cl. 426/34; 426/580

(57) ABSTRACT

A process for producing a fermented milk which comprises lowering the dissolved oxygen concentration in a starting mixture for producing the fermented milk to 5 ppm or less at the initiation of the fermentation and conducting the fermentation at a temperature of from 30° C. to 39° C., or adding a starter to the starting mixture for producing the fermented milk in an amount of from 25% to 50% based on the usual level and conducting the fermentation at a temperature of from 38° C. to 46° C.

### TECHNICAL FIELD

The present invention relates to a process for producing fermented milk with reduced milk fat content, or fermented milk from which the milk fat content is reduced than usual, which can prevent deterioration of its flavor and texture due to the reduction of the milk fat content without using an additive such as a substitute for milk fat and also can improve its flavor and texture to a level higher than the products having milk fat content of usual concentration; and to a fermented milk obtainable by the process.

### BACKGROUND ART

Fermented milk is an article of food broadly eaten as a typical member of health foods. However, when considered from the viewpoint of health food, general fermented milk contains approximately 3% by weight (hereinafter, the “by weight” is omitted) of milk fat content, so that cry for an article of low calorie fermented milk having a low fat content has been increasing because of the up-rush of diet intention. Thus, a large number of articles of fermented milk claiming low fat have been appearing on the market in recent years. However, since the milk fat content exerts a large influence upon the good milk flavor and texture possessed by fermented milk, there is a necessity to make up for or improve the good milk flavor and texture inevitably reduced by reducing the milk fat content, by a certain method in providing fermented milk having low milk fat content.

Most of such processes are processes in which low calorie additives substituting for the milk fat are added, and agar, gelatin and the like are mainly used as the substitutes. These substances are used for providing a “smooth texture”, substituting under pretence for the “smooth texture” including reduction of sourness provided by the milk fat. Accordingly, these are not applied to make up for the shortage of deterioration of milk flavor accompanied by the reduction of fat, particularly “richness of taste (bodily taste)”. Since influence of the shortage of this “richness of taste (bodily taste)” exerting particularly upon the deterioration of milk flavor is great, a large number of milk flavor providing agents for reinforcing milk flavor have been reported (e.g., Patent Reference 1) in addition to the aforementioned agar, gelatin and the like.

However, all of these methods have been proposed based on the idea of making up for the milk fat content by certain substitutes. Thus, from the viewpoint of obtaining more natural deliciousness, concern has been directed toward the development of a method for controlling or improving deterioration of flavor and texture without using the aforementioned milk fat substitutes, milk flavor providing agents or the like when possible, or even when an additive is used inevitably, using it as little as possible.

On the other hand, as the methods for giving fine texture to fermented milk and further improving hardness of the fermented milk tissue, the present inventors have reported that a novel fermented milk having fine and smooth flavor and a tissue hardness that can stand transportation and the like can be obtained when the fermentation is carried out at a fermentation temperature of from 30° C. to 37° C. (Patent Reference 2) or from 38° C. to 40° C. (Patent Reference 3) which is lower than usual, under a condition of reducing the dissolved oxygen concentration in the fermented milk mixture to 5 ppm or less. These were made using fermented milk having the milk fat content of general concentration as the object, but not using certain fermented milk which caused problems regarding its flavor and texture as a result of intentionally reducing the milk fat content.
Patent Reference 1: JP-A-2003-250482
Patent Reference 2: Japanese Patent No. 3644505
Patent Reference 3: Japanese Patent No. 3666871

### DISCLOSURE OF THE INVENTION

### Problems that the Invention is to Solve

The invention has been made for the purpose of providing a process for producing a fermented milk capable of effectively preventing deterioration of the smooth texture and milk flavor originated from the milk fat (the smooth texture and milk flavor are put together referred to as “taste and mouth feel of milk fat” hereinafter) which are lost when the milk fat content of fermented milk is intentionally reduced, without using milk fat substitutes, milk flavor providing agents or the like but based on an ingenuity on the production process, and the fermented milk obtained as the result in which the taste and mouth feel of milk fat is improved and the milk fat content is reduced. In addition, the invention has been made for the purpose of providing fermented milk having taste and mouth feel of milk fat of at least equivalent to or greater than that of usual fermented milk, regarding fermented milk in which the milk fat content was intentionally reduced, particularly fermented milk having a milk fat content of 1% or more.

### Means for Solving the Problems

With the aim of solving the aforementioned two problems, the inventors have conducted intensive studies and found as a result that a fermented milk having a clearly improved taste and mouth feel of milk fat in comparison with that of the fermented milk produced by an usual process and having low fat content can be obtained by carrying out the fermentation using a fermented milk mix in which the milk fat content was reduced from the usual concentration of about 3% to a level of from 0.1% to 2.0%, reducing dissolved oxygen concentration in the mix to 5 ppm or less, and lowering the fermentation temperature than usual and/or sharply decreasing the amount of the starter to be added to the mix from the usual additive amount.

In addition, it was found that, particularly when the milk fat content is 1.0% or more, a fermented milk having taste and mouth feel of milk fat of equal to or greater than that of the fermented milk having a milk fat content of about 3% produced by a usual method can be obtained, even when a milk fat substitute or milk flavor providing agent is not used.

Namely, the invention relates to the following (1) to (7).

(1) A process for producing fermented milk in which a milk fat content is from 0.1% by weight to 2.0% by weight, said process comprising:

reducing a dissolved oxygen concentration in a fermented milk mix to 5 ppm or less at the time of the start of fermentation; and

carrying out the fermentation at a fermentation temperature of from 30° C. to 39° C., to thereby improve taste and mouth feel of milk fat.

(2) A process for producing fermented milk in which a milk fat content is from 0.1% by weight to 2.0% by weight, said process comprising:

reducing a dissolved oxygen concentration in a fermented milk mix to 5 ppm or less at the time of the start of fermentation; and

setting an amount of a starter to be added to the fermented milk mix at from 25% to 50% of the amount thereof to be usually used and carrying out the fermentation at a fermentation temperature of from 38° C. to 46° C., to thereby improve taste and mouth feel of milk fat.

(3) A process for producing fermented milk in which a milk fat content is from 1.0% by weight to 2.0% by weight, said process comprising:

reducing a dissolved oxygen concentration in a fermented milk mix to 5 ppm or less at the time of the start of fermentation; and

carrying out the fermentation at a fermentation temperature of from 30° C. to 39° C., to thereby obtain a fermented milk having taste and mouth feel of milk fat equivalent to or greater than that of a fermented milk having an usual concentration of milk fat content, without using an additive which exerts an influence upon the taste and mouth feel of milk fat.

(4) A process for producing fermented milk in which a milk fat content is from 1.0% by weight to 2.0% by weight, said process comprising:

reducing a dissolved oxygen concentration in a fermented milk mix to 5 ppm or less at the time of the start of fermentation; and

setting an amount of a starter to be added to the fermented milk mix at from 25% to 50% of the amount thereof to be usually used and carrying out the fermentation at a fermentation temperature of from 38° C. to 46° C., to thereby obtain a fermented milk having taste and mouth feel of milk fat equivalent to or greater than that of a fermented milk having an usual concentration of milk fat content, without using an additive which exerts an influence upon the taste and mouth feel of milk fat.

(5) The process for producing fermented milk according to any one of (1) to (4), wherein the fermentation is carried out within such a period of time that the all fermentation steps are completed in one day.

(6) The process for producing fermented milk according to any one of (1) to (4), wherein the fermentation time is from 3 to 7 hours.

(7) A fermented milk which is obtainable by the process according to any one of (1) to (6).

In this connection, based on the nutritive components indication criteria, those which can claim “low fat” are those having a fat content of 3 g per 100 g food (milk fat content 3%). However, since the fat content of general products themselves is about 3% in the case of fermented milk, the highlighting of the “low fat” is given to products having a fat content of 1.5% or less. Also, the highlighting of the “fat-free” is given to products having a fat content of 0.5% or less. Effects of the invention are significant within the range of from this “low fat” region to “fat-free” region, and as is described later, the effects of the invention can be clearly verified from the products in which the milk fat concentration was reduced to about 2%. Accordingly, the object matters of the invention are not limited to the fermented milk which can express “low fat” or “fat-free”, and products having a milk fat content of 2.0% or less are used as the object matters of the invention, as fermented milk having smaller milk fat content then usual. That is, when the milk fat content of ordinary products is about 3% in the case of the conventional production process, it is able to feel reduction of taste and mouth feel of milk fat clearly when the milk fat content was reduced to 2.0%, from a result of a sensory test (Table 5), so that the fermented milk which require improvement of taste and mouth feel of milk fat by applying the invention is set to the fermented milk having a milk fat content of 2% or less.

When the reduction of fermentation temperature or reduction of the amount of a starter to be added, each independently, is carried out in combination with the reduction of dissolved oxygen concentration in the fermented milk mix to 5 ppm or less as described in the foregoing, it was confirmed that fermented milk having improved taste and mouth feel of milk fat can be obtained by carrying out the fermentation at a temperature of from 30° C. to 39° C. regarding the lowering of the fermentation temperature to a lower level than usual, and regarding the reduction of the amount of a starter to be added to a level lower than usual, fermented milk having improved taste and mouth feel of milk fat can be obtained by carrying out the fermentation with setting an additive amount at 25% to 50% of the amount thereof to be usually used and at a temperature of from 38° C. to 46° C. In addition, it was also confirmed that the fermentation time is within the period of from 3 hours to 7 hours under respective conditions, by which the fermentation process is completed within one day.

According to the invention, it is possible to use various conditions by combining both of the reduction of fermentation temperature and reduction of the amount of a starter to be added (e.g., fermentation temperature is set to 34° C. and amount of a starter to be added is set at 60% of usual amount, and the like), but this is not recommendable because of the presence of problems in that the combination becomes complex and the merit of each condition is diluted. For example, in the case of a process in which the amount of a starter to be added is sharply reduced, the fermentation can be carried out with the additive amount at from 25% to 50% of the usual additive amount and at a fermentation temperature of from 38° C. to 46° C., but when the fermentation is carried out not at a low temperature but at an ordinary temperature of for example 40° C. or more by considering the above as a merit, it is rational to use a method in which the amount of a starter to be added is reduced.

However, a necessity to combine both of them occurs, because, particularly in the critical areas of respective conditions, yield of the product to be obtained can be improved by combining the two factors of fermentation temperature and additive amount of starter, rather than the individual case. For example, since the fermentation temperature of 39° C. is the upper limit temperature for obtaining fermented milk with improved taste and mouth feel of milk fat under the temperature condition alone, there is a case in which a product having the intended properties cannot be obtained, and yield of the product tends to be reduced. Accordingly, it becomes possible to improve yield of the product by combining a condition for reducing the additive amount of the starter. Because of the above merit, in the case of the process in which the additive amount of the starter is reduced, the applying temperature range was started from 38° C. which partially overlaps with the condition of fermentation temperature alone.

Even in the case of the process of the invention, when the milk fat content of the fermented milk mix is sharply reduced to a level of approximately from less than 1.0% to 0.1%, it is difficult to obtain the taste and mouth feel of milk fat on all of the sensory evaluation items at similar level of usual fermented milk having a milk fat content of about 3%, under a condition of not using milk fat substitutes and the like additives. However, even at such a low milk fat concentration, taste and mouth feel of milk fat of the fermented milk produced by the process of the invention is clearly improved in comparison with usual products, and for example, it was confirmed that the score of the “richness of taste (bodily taste)” of the fermented milk having a milk fat content of 0.5% produced by the process of the invention is clearly high in comparison with the fermented milk having a milk fat content of 1.5% obtained by an usual fermentation method (Table 3a). In addition, it was also confirmed that even under conditions of the milk fat content of 0.1% which is extremely low, the score of the “richness of taste (bodily taste)” of the fermented milk produced by the process of the invention becomes similar to that of the fermented milk having a milk fat content of 1.5% obtained by an usual fermentation method (Table 3b).

### ADVANTAGE OF THE INVENTION

As described in the above, the invention has an advantage in that deterioration of the taste and mouth feel of milk fat accompanied by the reduction of milk fat can be prevented without using milk fat substitutes, milk flavor providing agents or the like but based on an ingenuity on the production process alone, under conditions of a low milk fat content of from 0.1% to 2.0%. Particularly, since the taste and mouth feel of milk fat similar to or greater than that of ordinary products can be obtained at a milk fat content of from 1.0% to 1.5% without using additives, it has an advantage in that both of the highlighting of “low fat” and the highlighting of “additive-free” can be given simultaneously. That is, when the milk fat content is between 1.0% and 1.5%, the present invention has a novel and remarkable advantage of being able to provide low fat fermented milk which is “additive-free” and also “delicious”, regardless of the “low fat”.

### BEST MODE FOR CARRYING OUT THE INVENTION

The following describes the invention in detail.

Any milk may be used in accordance with the invention, with no specific limitation, so long as the milk is mammalian milk. Although the types thereof are not limited to the followings, they include cow milk, goat milk, sheep milk, water buffalo milk, swine milk and human milk. Among them, cow milk from Holstein species and Jersey species is preferably used owing to the ready availability and the cost.

As the lactic acid bacterial starter to be inoculated into the mix according to the invention, one or two or more kinds selected from lactic acid bacteria and yeast generally used in producing fermented milk may be used, as well as L. bulgaricus, S. thermophilus, and L. lactis. In accordance with the invention, a starter based on a mixture starter of L. bulgaricus and S. thermophilus, which is standardized as yogurt starter according to the Codex Standard, is preferably used. Taking account of the fermentation temperature and fermentation conditions for the intended fermented milk, other lactic acid bacteria such as L. gasseri and Bifidobacterium may be added, using the above-mentioned yogurt starter as the basis.

According to the invention, reduction of the fermentation temperature and reduction of the additive amount of the starter, to be combined with the reduction of dissolved oxygen in the fermented milk mix, can be carried out by combining each independently with the dissolved oxygen reducing method, or by combining conditions for both of them and then combining with the dissolved oxygen reducing method. However, in order to enjoy the merits of respective conditions, it is desirable from the viewpoint of process control to combine them each independently with the dissolved oxygen reducing method.

Firstly, when the reduction of the fermentation temperature is solely combined with the dissolved oxygen reducing method, a temperature within the range of from 30° C. to 39° C. can be employed. This condition is set to a temperature range in which its highest temperature is slightly lower than the condition disclosed in Japanese Patent No. 3666871. The reason for this is unclear, but it is considered that low milk fat content of the fermented milk mix to be employed exerts some influence thereon. In this case, since the fermentation time is prolonged at a temperature of around 30° C., and there is a tendency that the improvement of the taste and mouth feel of milk fat is deteriorated at around 39° C., preferred temperature is within a range of from 32° C. to 38° C., and more preferably from 34° C. to 37° C.

Next, when reduction of the additive amount of the starter is solely combined with the dissolved oxygen reducing method, an additive amount of the starter at from 25% to 50% of the amount thereof to be usually used is employed. In addition, a fermentation temperature within a range of from 38° C. to 46° C. can be used under this condition. Under a high temperature condition, the taste and mouth feel of milk fat can be ensured by further reducing the amount of the starter to be added. However, since the temperature of 46° C. is the threshold value which can effect improvement of the taste and mouth feel of milk fat, it becomes a temperature at which control of the production process is difficult to carry out than other temperatures. Accordingly, the temperature is preferably within a range of from 38° C. to 45° C., more preferably from 39° C. to 43° C. The merit of employing this method is that the fermentation can be carried out at the fermentation temperature usually employed, and when the usual fermentation temperature is employed, in addition to the easiness of the temperature control similar to the case of ordinary products, it also has a merit of being able to sharply reduce generation of various germs and the like risks.

Regarding the usual additive amount of the starter which becomes the basis of the additive amount of the starter according to the invention described in the above, the additive amount of a starter, which is used when a fermentation that gives a lactic acid acidity of 0.7% after 3 hours of fermentation at a fermentation temperature of 43° C. is carried out using a fermented milk mix without being subjected to a dissolved oxygen reducing treatment, is used as the usual additive amount of the starter, and the amount is regarded as 100%. Illustratively, about 2.0% by weight of a starter with respect to the total amount of the fermented milk mix is added under usual conditions. Contrary to this, the amount of the starter to be added in the case of the invention is from 0.5% by weight to 1.0% by weight with respect to the total amount of the fermented milk mix, which is approximately from 25% to 50% of the usual additive amount.

The mix of the raw materials to be used in the invention can be obtained by heating and dissolving raw materials generally used for the production of fermented milk, such as milk, skim milk, skim milk powder, other milk materials, sugar, saccharides, perfume, water and the like, or when milk fat substitutes and the like are used, by adding previously heated and dissolved gelatin liquid, agar liquid, pectin and the like thereto and mixing them. However, according to the invention, for example in the case that the milk fat is approximately from 1.0% to 2.0%, it is possible to provide a product which is equivalent to a product containing a milk fat of usual concentration or is further rich in the taste and mouth feel of milk fat, under a condition without adding milk fat substitutes and the like, so that it can be said that, within the aforementioned range of concentration, an embodiment in which gelatin and the like are not added is more desirable embodiment of the invention. Thus, in the case of the invention, actual addition of a milk fat substitute or the like may be considered when a product of the “fat-free” range, in which the milk fat becomes 0.5% or less, is provided.

In this connection, control of the milk fat content between 0.1% and 2% in producing the fermented milk of the invention can be carried out by controlling the mixing ratio of raw milk and skim milk powder. In this case, when skim milk powder is used solely without using fresh milk but using generally distributed skim milk powder, the milk fat content becomes about 0.1% when SNF (solid non fat) is adjusted to the same level of usual fermented milk by residual fat in the skim milk powder.

The mix of raw materials having adjusted milk fat concentration obtained in the above manner is homogenized, sterilized and then cooled to about the predetermined temperature (fermentation temperature). The treatment for reducing dissolved oxygen concentration, which is described later, may be carried out in this condition, but when the dissolved oxygen concentration is reduced by replacement with nitrogen or the like means, the dissolved oxygen concentration reducing treatment may not be carried out at this stage. Subsequently, an usual additive amount, or an amount reduced from the usual additive amount, of a lactic acid bacillus starter is inoculated, and the fermentation is started by filling it in a tank in the case of stirred type yogurt, or the fermentation is started by filling it in an individual container for distribution use in the case of post-fermentation. In addition, a syrup or the like may be added to the mixture after completion of the fermentation.

As a method for reducing the dissolved oxygen concentration in the mix, a method via gas substitution treatment with inactive gas, a membrane separation method using deoxygenated membrane and the like may be carried out, without any particular limitation. Herein, the dissolved oxygen concentration in the mix is preferably reduced to 5 ppm or less, more preferably 3 ppm or less. Among the methods described above, the method employing inactive gas substitution may be done after starter addition and has fewer limitations in terms of the steps, in comparison with the other methods.

The method employing inactive gas substitution is described below. The substitution treatment may satisfactorily be done within the period of from the stage of preparing a raw material mix to the stage after the starter inoculation and before the start of fermentation, and the timing for the substitution may appropriately be set during the production steps. However, since it is important that the dissolved oxygen concentration is maintained to be reduced at the start of fermentation, the inactive gas substitution of the mix is preferably done during the period immediately before to immediately after the starter inoculation.

Regarding dissolved oxygen concentration in the mixture at the time of the start of fermentation, lower concentration produces good results, and this tendency is the same as the result disclosed in Japanese Patent No. 3644505 even in the case of the method of the invention. For example, it is 5 ppm or less, preferably 3 ppm or less, when temperature of the mixture is about 40° C. This effect is common to the case of the reduction of temperature and the case of the reduction of additive amount or the starter, and from the process point of view, it acts in such a manner that the fermentation time is shortened, so that the fermentation can be carried out within a period of from 3 to 7 hours when any one of the methods is used.

In the case that inactive gas substitution is carried out as a process for reducing the dissolved oxygen concentration, inactive gases such as nitrogen gas, argon gas and helium gas may be used. Especially, nitrogen gas is more preferably used as an inactive gas for general use in food. As a method for substituting dissolved oxygen with inactive gas, conventional methods such as a method including allowing these inactive gases to bubble directly into the mix, a method by means of static mixer, and a method including placing a gas together with the mix into a mixer for agitation may be employed.

When a membrane separation method is carried out as the method for reducing dissolved oxygen concentration, a hollow fiber membrane (MHF304KM mfd. by Mitsubishi Rayon, or the like) can be used as the deoxidation membrane. Regarding the way of using it, it may be used by referring to a conventional method for using membranes, and operation of the membrane separation method becomes possible when dissolved oxygen concentration is reduced by applying it to the mixture before the addition of a starter.

In the case of the process of the invention, the fermentation temperature and additive amount of starter are set from the viewpoint of completing the fermentation within such a period of time that the whole fermentation process is finished in one day. Accordingly, when a long period fermentation is taken into consideration, it is considered that there may be a case of using different temperature range and amount of the starter to be added. However, it is obvious that such a technique is a technique which is within the category of the invention, with the proviso that it shows an effect of obtaining fermented milk having improved taste and mouth feel of milk fat by reducing dissolved oxygen concentration in the fermented milk mix to 5 ppm or less, and carrying out the fermentation by lowering the fermentation temperature from that in the usual fermentation condition, and/or sharply decreasing the amount of the starter to be added to the fermented milk mix from the usual additive amount, in producing a fermented milk in which the milk fat content is reduced to a level of from 0.1% to 2.0%, as the basic point of view.

### EXAMPLES

The following describes the invention further in detail based on inventive examples and test examples, but the invention is not limited thereto.

### INVENTIVE EXAMPLE 1

Production of Low Fat Fermented Milk by the Process of the Invention (Fermentation Temperature 38° C.)

A mixture was prepared by mixing 35.7 kg of milk, 6.8 kg of skim milk powder and 53.5 kg of water. By referring to Standard Tables of Food Composition in Japan, 5^{th} revised edition, composition of the mixture was calculated with assuming that composition of milk includes 8.8% of SNF and 3.8% of milk fat and composition of skim milk powder includes 95.2% of SNF and 1.0% of milk fat. Next, the thus formulated mixture was sterilized by heating at 95° C. for 5 minutes and then cooled down to 38° C. to carry out inoculation of 2.0% of a lactic acid bacilli starter {a mixed culture of Lactobacillus bulgaricus (L. bulgaricus JCM 1002T),and Streptococcus thermophilus (S. thermophilus ATCC 19258)}. Nitrogen gas was mixed with and dispersed in this mixture using a pipe, thereby adjusting dissolved oxygen concentration to 5 ppm or less. This was filled in a container and allowed to undergo the fermentation at 38° C., and when the lactic acid acidity reached 0.7% (fermentation period 3 hours), this was cooled down to 10° C. or lower to stop the fermentation and used as the final product. Composition of the final product of this case includes 10.0% of SNF and 1.5% of milk fat content.

In addition, when fermented milk obtained by carrying out usual fermentation of fermented milk mix having an usual concentration (3.0%) of milk fat at 43° C. for 3 hours was used as a control product and its taste and mouth feel of milk fat was compared with that of the aforementioned product of the invention, the product of the invention showed clearly stronger taste and mouth feel of milk fat than that of the control product. (See Test Example 1, Table 1a)

In this connection, SNF of each milk fat-containing preparation of each Inventive Example and Comparative Example was fixed to 10.0%. Thus, the total solid content becomes low as the milk fat content is low. For example, in the case of fermented milk having a milk fat content of 1.5%, the total solid content becomes 11.5%, while the total solid content of fermented milk having a milk fat content of 0.5% is 10.5%. However, SNF was not used to compensate for the solid content equivalent to the reduced milk fat content. This is because when SNF is increased, an effect to compensate for the bodily taste is generated due to this. Accordingly, it can be judged that the effect of the process of the invention obtained this time was produced clearly by the process of the invention.

In addition, the lactic acid acidity was calculated by titrating 0.1 N NaOH using phenolphthalein as the indicator.

### TEST EXAMPLE 1

Comparison of Taste and Mouth Feel of Milk Fat of the Low Fat Fermented Milk of the Invention with Usual Product

By applying the production process of Inventive Example 1 to fermented milk mixes having varied milk fat concentration, the fermented milk of the invention having a milk fat content of 1.5%, 1.3%, 1.0% or 0.9% was prepared, and a sensory evaluation test by a two point strength test for simultaneously prepared fermented milk of ordinary fermentation method (control method) having a milk fat content of 3.0% was carried out by a panel of 8 or 9 experts. The test was carried out on 4 points by adding “degree of sourness” as a reference to the 3 evaluation items “smoothness on the tongue”, “mellowness of taste” and “richness of taste (body)”. In addition, the result of particularly “richness of taste (body)” was evaluated most predominantly as a sensory evaluation representing the taste and mouth feel of milk fat. The thus obtained results are shown in of Tables 1a to 1d. As a result, the fermented milk of the invention having a milk fat content of 1.0% was given almost the same evaluation as the ordinary product in terms of the “richness of taste (body)” and “smoothness on the tongue”. The fermented milk of the invention having a milk fat content of 1.3% or 1.5% was judged equivalent in terms of the “smoothness on the tongue” and clearly “stronger” than the ordinary product in two points of the “mellowness of taste” and “richness of taste (body)”. Based on the above, it was confirmed that the products of the invention are turned into “low fat fermented milk with good taste” having a taste and mouth feel of milk fat equal to or greater than that of an usual product (milk fat content 3%), when the milk fat content is 1.0% or more.

TABLE 1a
P: milk fat 3.0% (control method) vs. Q: milk
fat 1.5% (the process of the invention)

| n = 9 | P is stronger | Q is stronger | Ambiguous |
|---|---|---|---|
| Smoothness on the tongue | 3 | 4 | 2 |
| Mellowness of taste | 1 | 7 | 1 |
| Richness of taste (body) | 1 | 5 | 3 |
| Degree of sourness | 8 | 0 | 1 |

TABLE 1b
P: milk fat 3.0% (control method) vs. Q: milk
fat 1.3% (the process of the invention)

| n = 9 | P is stronger | Q is stronger | Ambiguous |
|---|---|---|---|
| Smoothness on the tongue | 3 | 4 | 2 |
| Mellowness of taste | 1 | 6 | 2 |
| Richness of taste (body) | 1 | 6 | 2 |
| Degree of sourness | 5 | 2 | 2 |

TABLE 1c
P: milk fat 3.0% (control method) vs. Q: milk
fat 1.0% (the process of the invention)

| n = 8 | P is stronger | Q is stronger | Ambiguous |
|---|---|---|---|
| Smoothness on the tongue | 5 | 3 | 0 |
| Mellowness of taste | 8 | 0 | 0 |
| Richness of taste (body) | 4 | 4 | 0 |
| Degree of sourness | 2 | 5 | 1 |

TABLE 1d
P: milk fat 3.0% (control method) vs. Q: milk
fat 0.9% (the process of the invention)

| n = 8 | P is stronger | Q is stronger | Ambiguous |
|---|---|---|---|
| Smoothness on the tongue | 6 | 1 | 1 |
| Mellowness of taste | 8 | 0 | 0 |
| Richness of taste (body) | 5 | 3 | 0 |
| Degree of sourness | nt | nt | nt |

### INVENTIVE EXAMPLE 2

Production of Low Fat Fermented Milk by the Process of the Invention (Starter Reducing Method)

The same production of Inventive Example 1 was carried out, except that amount of the lactic acid bacilli starter to be added was changed to 0.8% (40% of usual additive amount) and the fermentation temperature was changed to 43° C. When the flavor and texture of the thus obtained product were compared with those of the usual product having a milk fat content of 3.0%, it was confirmed that it shows almost the same taste and mouth feel of milk fat of the usual product having a milk fat concentration of 3.0% as shown in Table 2.

TABLE 2
P: milk fat 3.0% (control method) vs. S:
milk fat 1.5% (starter reducing method)

| n = 8 | P is stronger | S is stronger | Ambiguous |
|---|---|---|---|
| Smoothness on the tongue | 5 | 2 | 1 |
| Mellowness of taste | 4 | 3 | 1 |
| Richness of taste (body) | 3 | 2 | 3 |
| Degree of sourness | 7 | 0 | 1 |

### TEST EXAMPLE 2

Sensory Evaluation Test of Usual Low Fat Fermented Product (Milk Fat 1.5%) and Fat-Free Products of the Invention (Milk Fat 0.5%, 0.1%)

Since there was a probability of resulting in a one-sided evaluation result by a sensory evaluation test with fermented milk having an usual concentration (3%) of milk fat content when the milk fat content is 1% or less, fermented milk prepared by carrying out usual fermentation by reducing the milk fat to 1.5% (control product) and the fermented milk of the invention having a milk fat concentration of 0.5% or 0.1% were subjected to the same sensory evaluation test of Test Example 1. The thus obtained results are shown in Table 3a and Table 3b. Consequently, a result that the fermented milk of the invention having a milk fat content of 0.5% is “stronger” than the fermented milk having a milk fat content of 1.5% produced by the usual production process in terms of the “richness of taste (body)”, was obtained. Also, a result that the fermented milk of the invention having a milk fat content of 0.1% is “equivalent” to the control product in terms of the “richness of taste (body)”, was obtained. On the other hand, the “smoothness on the tongue” of both of them was inferior to that of the control product, so that it was revealed that it is necessary to examine addition of a milk fat substitute or the like regarding the synthetic taste and mouth feel of milk fat which took all of the evaluation axes into consideration. However, it was able to confirm that taste and mouth feel of milk fat of the fermented milk of the invention is clearly improved also in the area where “fat-free” can be expressed.

TABLE 3a
P: milk fat 1.5% (control method) vs. Q: milk
fat 0.5% (the process of the invention)

| n = 8 | P is stronger | Q is stronger | Ambiguous |
|---|---|---|---|
| Smoothness on the tongue | 8 | 0 | 0 |
| Mellowness of taste | 5 | 2 | 1 |
| Richness of taste (body) | 1 | 5 | 2 |
| Degree of sourness | 5 | 2 | 1 |

TABLE 3b
P: milk fat 1.5% (control method) vs. Q: milk
fat 0.1% (the process of the invention)

| n = 8 | P is stronger | Q is stronger | Ambiguous |
|---|---|---|---|
| Smoothness on the tongue | 3 | 3 | 2 |
| Mellowness of taste | 3 | 4 | 1 |
| Richness of taste (body) | 3 | 3 | 2 |
| Degree of sourness | 7 | 0 | 1 |

### TEST EXAMPLE 3

Examination on the Relationship Between Fermentation Temperature and Taste and Mouth Feel of Milk Fat and the Like

Examination was carried out on the influence of fermentation temperature upon taste and mouth feel of milk fat and tissue hardness, in the case that the milk fat content is 1.5%. Production was carried out in accordance with the production process of Inventive Example 1, except that the fermentation temperature and fermentation time were varied, and fermented milk prepared by carrying out the usual fermentation with milk fat of 3% was used as the comparative object. In this case, examining range of the fermentation temperature was set using completion of the fermentation within 7 hours as a measure. In addition, as an example of the application product of the invention, evaluation was made also on the suitability of the thus obtained fermented milk, when applied to stirred type (mainly a dessert type) or set type (mainly a hard type) fermented milk using its tissue hardness as a measure. The results are shown in Table 4.

TABLE 4
Evaluation products are 1.5% in milk fat content

| Fermentation | Flavor | Optimum commodity |
|---|---|---|
| temperature (° C.) | evaluation | form |
| 40 | Δ | — |
| 39 | ◯ | Set type |
| 38 | ⊚ | Set type |
| 37 | ⊚ | Set type |
| 36 | ⊚ | Set type |
| 35 | ⊚ | Set type |
| 34 | ⊚ | Set type |
| 33 | ⊚ | Stirred type |
| 32 | ⊚ | Stirred type |
| 31 | ⊚ | Stirred type |
| 30 | ⊚ | Stirred type |

Evaluation
⊚: It has a taste and mouth feel of milk fat superior to that of usual product (control method, milk fat 3%).
◯: It has a taste and mouth feel of milk fat equivalent to that of usual product.
Δ: It has a body, but its taste and mouth feel of milk fat is inferior to that of usual product.
Note 1:
Less than 30° C. was not evaluated because the fermentation time exceeds 7 hours.
Note 2:
Commodity form was evaluated mainly by the hardness of tissue.
Set type yogurt: harder
Stirred type yogurt: softer

### TEST EXAMPLE 4

Examination on the Milk Fat Concentration at Which Deterioration of Flavor is Felt

In order to evaluate application range of the invention, sensory evaluation test was carried out on usual fermented milks having different milk fat concentrations. Results of the sensory test on the usual fermented milk having usual milk fat concentration (3.0%) and that in which the milk fat content was reduced to 2.0% are shown in Table 5. As a result, it was confirmed that evaluation of the “richness of taste (body)” becomes slightly unstable when the milk fat concentration is reduced to 2.0%, but evaluation of the fermented milk having a milk fat content of 2.0% is reduced on all of the three evaluation axes “smoothness on the tongue” “mellowness of taste” and “richness of taste (body)”. Accordingly, in synthetically judging, reduction of the taste and mouth feel of milk fat can be clearly felt when the milk fat concentration is reduced to 2.0%, so that the applicable product of the invention was determined as the fermented milk having a milk fat content of 2.0% or less.

TABLE 5
P: milk fat 3.0% (control method)
vs. R: milk fat 2.0% (control method)

| n = 8 | P is stronger | R is stronger | Ambiguous |
|---|---|---|---|
| Smoothness on the tongue | 8 | 0 | 0 |
| Mellowness of taste | 8 | 0 | 0 |
| Richness of taste (body) | 4 | 2 | 2 |
| Degree of sourness | 2 | 4 | 2 |

While the invention has been described in detail and with reference to specific embodiments thereof, it will be apparent to one skilled in the art that various changes and modifications can be made therein without departing from the scope thereof.

This application is based on Japanese patent application No. 2005-300646 filed Oct. 14, 2005, the entire contents thereof being hereby incorporated by reference.

Further, all references cited herein are incorporated in their entireties.

### INDUSTRIAL APPLICABILITY

The invention has an advantage in that deterioration of the taste and mouth feel of milk fat accompanied by the reduction of milk fat can be prevented without using milk fat substitutes, milk flavor providing agents or the like but based on an ingenuity on the production process alone, under conditions of a low milk fat content of from 0.1% to 2.0%. Particularly, since the taste and mouth feel of milk fat similar to or greater than that of ordinary products can be obtained at a milk fat content of from 1.0% to 1.5% without using additives, it has an advantage in that both of the highlighting of “low fat” and the highlighting of “additive-free” can be given simultaneously. That is, when the milk fat content is between 1.0% and 1.5%, the present invention has a novel and remarkable advantage of being able to provide low fat fermented milk which is “additive-free” and also “delicious”, regardless of the “low fat”.

1. A process for producing fermented milk in which a milk fat content is from 0.1% by weight to 2.0% by weight, said process comprising:
reducing a dissolved oxygen concentration in a fermented milk mix to 5 ppm or less at the time of the start of fermentation; and
carrying out the fermentation at a fermentation temperature of from 30° C. to 39° C., to thereby improve taste and mouth feel of milk fat.

2. A process for producing fermented milk in which a milk fat content is from 0.1% by weight to 2.0% by weight, said process comprising:
reducing a dissolved oxygen concentration in a fermented milk mix to 5 ppm or less at the time of the start of fermentation; and
setting an amount of a starter to be added to the fermented milk mix at from 25% to 50% of the amount thereof to be usually used and carrying out the fermentation at a fermentation temperature of from 38° C. to 46° C., to thereby improve taste and mouth feel of milk fat.

3. A process for producing fermented milk in which a milk fat content is from 1.0% by weight to 2.0% by weight, said process comprising:
reducing a dissolved oxygen concentration in a fermented milk mix to 5 ppm or less at the time of the start of fermentation; and
carrying out the fermentation at a fermentation temperature of from 30° C. to 39° C., to thereby obtain a fermented milk having taste and mouth feel of milk fat equivalent to or greater than that of a fermented milk having an usual concentration of milk fat content, without using an additive which exerts an influence upon the taste and mouth feel of milk fat.

4. A process for producing fermented milk in which a milk fat content is from 1.0% by weight to 2.0% by weight, said process comprising:
reducing a dissolved oxygen concentration in a fermented milk mix to 5 ppm or less at the time of the start of fermentation; and
setting an amount of a starter to be added to the fermented milk mix at from 25% to 50% of the amount thereof to be usually used and carrying out the fermentation at a fermentation temperature of from 38° C. to 46° C., to thereby obtain a fermented milk having taste and mouth feel of milk fat equivalent to or greater than that of a fermented milk having an usual concentration of milk fat content, without using an additive which exerts an influence upon the taste and mouth feel of milk fat.

5. The process for producing fermented milk according to claim 1, wherein the fermentation is carried out within such a period of time that the all fermentation steps are completed in one day.

6. The process for producing fermented milk according to claim 1, wherein the fermentation time is from 3 to 7 hours.

7. A fermented milk which is obtainable by the process according to claim 1.

8. A process for producing fermented milk in which a milk fat content is from 1.0% by weight to 2.0% by weight, characterized in that, by reducing a dissolved oxygen concentration in a fermented milk mix to 5 ppm or less at the time of the start of fermentation and by carrying out the fermentation at a fermentation temperature of from 30° C. to 39° C., the taste and mouth feel of milk fat of said fermented milk is, without addition of a milk-fat alternative or a milk flavoring agent, equivalent to or greater than that of a fermented milk having 3% by weight of a milk fat content produced using a general method.

9. A process for producing fermented milk in which a milk fat content is from 0.1% by weight to less than 1.0% by weight, characterized in that, by reducing a dissolved oxygen concentration in a fermented milk mix to 5 ppm or less at the time of the start of fermentation and by carrying out the fermentation at a fermentation temperature of from 30° C. to 39° C., the taste and mouth feel of milk fat of said fermented milk is, without addition of a milk-fat alternative or a milk flavoring agent, equivalent to or greater than that of a fermented milk having 1.5% by weight of a milk fat content produced using a general method.

10. A process for producing fermented milk in which a milk fat content is from 0.1% by weight to 2.0% by weight, characterized in that the dissolved oxygen concentration in a fermented milk mix is reduced to 5 ppm or less at the time of the start of fermentation, a starter with an amount from 50% to 25% of its generally-added amount is added to the fermented milk mix, and the fermentation is carried out at a fermentation temperature of from 38° C. to 46° C.
